(19) United States
(12) Patent Application Publication
(10) Pub. No.: US 2010/0325535 A1
(43) Pub. Date: Dec. 23, 2010

(54) SYSTEM AND METHOD FOR ADDING NEW CONTENT TO A DIGITIZED DOCUMENT

(76) Inventor: Prakash Reddy, Fremont, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/489,232

(22) Filed: Jun. 22, 2009

(51) Int. Cl. G06F 17/00

(52) U.S. Cl. 715/246; 715/255

(57) ABSTRACT

A system and method is disclosed for adding content to a digitized document The method discloses: receiving the digitized document; identifying a set of original content areas; defining a set of new content space areas after the set of original content areas have been subtracted from a total area in the finished document; and inserting a set of new content into the set of new content space areas. The system discloses; a page detection module for receiving the digitized document; an original content identification module for identifying a set of original content areas; a new content space identification module for defining a set of new content space areas after the set of original content areas have been subtracted from a total area in the finished document; and a new content addition module for inserting a set of new content into the set of new content space areas.

### CROSS-REFERENCE TO RELATED OR CO-PENDING APPLICATIONS

This application relates to co-pending U.S. patent application Ser. No. 12/360,807, entitled “System And Method For Removing Artifacts From A Digitized Document,” filed on Jan. 27, 2009, by Reddy et al. These related applications are commonly assigned to Hewlett-Packard Development Co. of Houston, Tex.

### BACKGROUND OF THE INVENTION

### Field of the Invention

The present invention relates generally to systems and methods for republishing digitized documents.

### BRIEF DESCRIPTION OF THE DRAWINGS

Some embodiments of the invention are described, by way of example, with respect to the following figures:

FIG. 1 is one embodiment of a system for adding new content to a digitized document;

FIG. 2 is a pictorial diagram of one embodiment of a digitized document page with original content;

FIG. 3 is a pictorial diagram of one embodiment of a new document page with blank space identified,

FIG. 4 is a pictorial diagram of one embodiment of the new document page with new content space identified;

FIG. 5 is a pictorial diagram of one embodiment of the new document page with new content added; and

FIG. 6 is a flowchart of one embodiment of a method for adding new content to a digitized document.

### DETAILED DESCRIPTION OF THE PREFERRED EMBODIMENT

Digital content creation and conversion is a significant activity in modern times. Not only are existing digital files and documents being created and saved, but new digital information is being created from other non-digital information mediums, including contemporary and historic book and magazine collections fixed in paper and previously stored in libraries, vaults, and the like. As digital copies of books become available they can be used for online viewing, searching, reprinting etc. A common technique for digitizing such documents is to scan them using scanners or digital cameras.

There, however, is a need to ensure that such digitization efforts can be commercially viable. For example, the costs of scanning, cleanup, storage and bandwidth are the key inhibitors for making all books available online. By providing a method for monetize the viewing of these books, content owners will be encouraged to support the initial investment needed to bring the books on-line, and would help subsidize the cost of reprinting such books, magazines, and other documents.

One of the most effective and proven methods of monetizing online content has been to embed the advertisement in the content, thereby making it an integral part of the content. Typically hiss is done manually by the content owner through: carefully constructing the pages such that the ads appear properly embedded and flow with the content; inserting fill pages ads between pages of content; and/or placing ads outside of the page content but within the web page. Such manual efforts not only delay creation of derivative works, but are also costly and tend to be more rigid and inflexible with regard to the advertisement displayed with the content.

The present invention addresses and remedies many, if not all, of the problems discussed above. The present invention describes techniques for automatically embedding (i.e. adding) advertisements and other new content with the original content.

One key benefit of the present invention enables new content to be added to the original content without requiring prior knowledge or control of the original content's layout. Thus, given a collection of scanned pages containing variable amounts of content, the present invention automatically determines, from a finished document output size and available new content (e.g. advertisements), which of the finished document's pages can host new content, and where such new content can be placed.

Such automatic embedding of new content also enables greater flexibility during online viewing, or searching, as well as when the original content is reprinted since different sets of new content (e.g. advertisements) can be added to the original content each time. This is an important advantage over traditional ad placement methods.

Details of the present invention are now discussed.

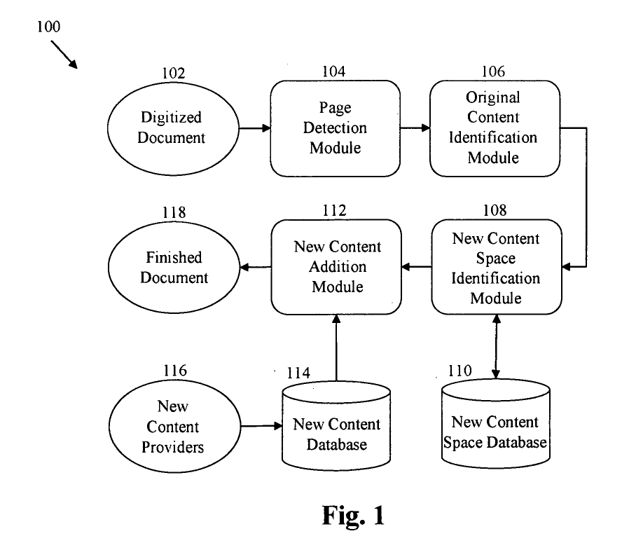

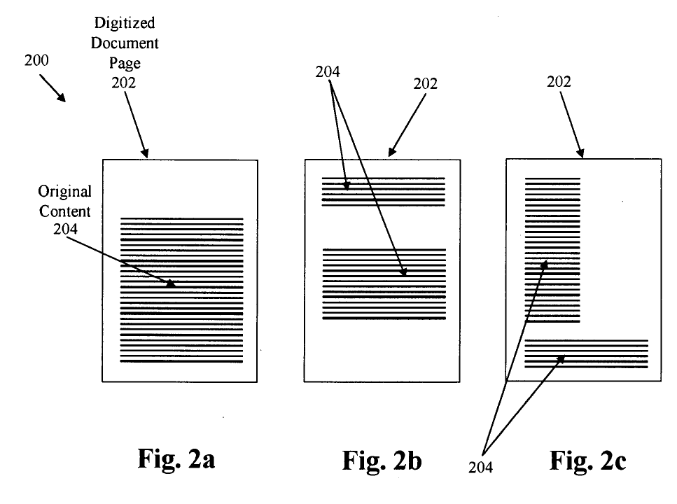

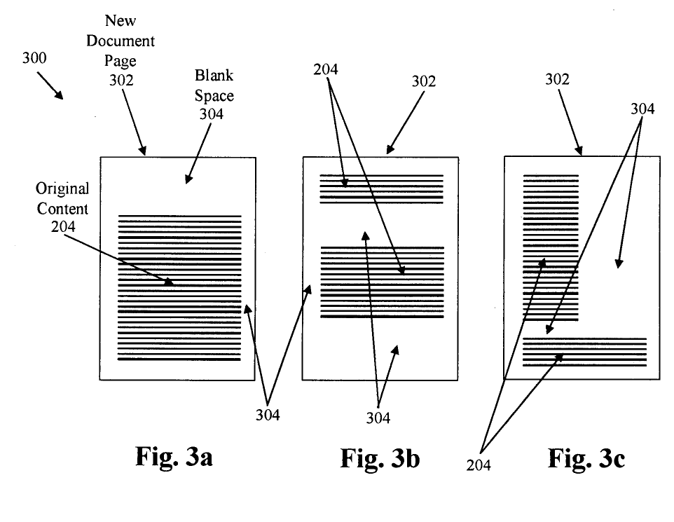

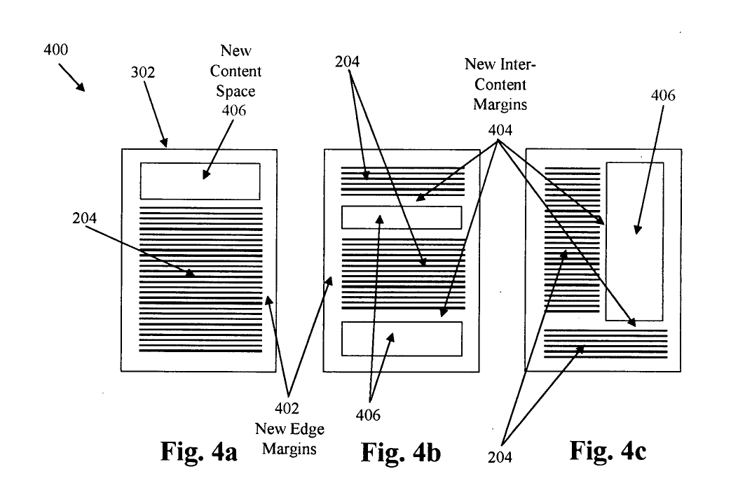

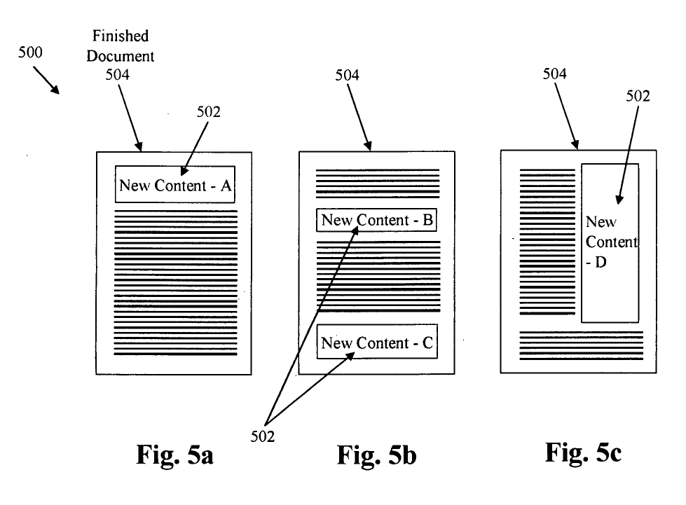

FIG. 1 is one embodiment of a system 100 for adding new content to a digitized document 102. FIG. 2 is a pictorial diagram of one embodiment of a digitized document page 202 with original content 204. FIG. 3 is a pictorial diagram of one embodiment of a new document page 302 with blank space 304 identified. FIG. 4 is a pictorial diagram of one embodiment of the new document page 302 with new content space 404 identified. FIG. 5 is a pictorial diagram of one embodiment of the new document page 302 with new content 502 added. To facilitate understanding, FIGS. 1 through 5 are discussed together.

A “document”, which is subsequently digitized, is herein defined to include any medium of expression, including books, magazines, photos, images, video, media, or any other medium capable of being digitized. Note that while the invention will be discussed primarily with reference to a document which is a book, the teachings of the present invention also apply to these other document types.

A page detection module 104, within the system 100, receives the digitized document 102 from a source such as a storage device, a scanner, a digital camera, or other hardware. The digitized document is wholly or partially formatted as an image file. Image files include either pixel or vector (geometric) data that are rasterized to pixels when displayed. Raster formats include: JPEG, TIFF, RAW, PNG, GIF, BMP, PPM, PGM, PBM, XBM, ILBM, WBMP, and PNM. Vector formats include: CGM, and SVG.

The image format as defined herein, does not in itself (i.e. by its format coding) separately give meaning to different portions of the digitized document 102. For example, the image format would represent any text within the digitized document 102 using a same set of format rules (e.g. perhaps by assigning a gray-scale, brightness, and/or color code to each pixel in the digitized document 102) as any other portion of the digitized document 102, such as a margin region.

The page detection module 104 uses known techniques to distinguish a digitized document page 202 (see FIG. 2), within the digitized document 102, from extraneous information such as the device or surface from which the page was scanned (e.g. a scanner's glass plate, or the surface of a desk from which a photo of the page was captured). Next, the page detection module 104 crops out the extraneous information from the digitized document 102 and preserves just the digitized document page 202. In an alternate embodiment, the digitized document 102 has already been cropped to the digitized document page 202, eliminating the need for the page detection module 104.

An original content identification module 106 then receives the digitized document page 202 from the page detection module 104 and identifies original content 204 (see FIG. 2). The original content 204 is simulated by multiple sets of parallel lines, as shown in FIGS. 2a, 2b, and 2c.

The original content identification module 106 preferably uses known techniques to automatically distinguish the original content 204 from the digitized document page 202 (see FIG. 2). Manual editing techniques can be used to separately identify the original content 204 as well, and may be necessary should the automated techniques yield unacceptable results.

The “Original Content” 204 is herein defined as that portion of the digitized document page 202 which the system 100 has been tuned to select for inclusion in subsequent derivative works. In one embodiment, such content includes typed text, illustrations, and/or photos on the page of a book. In another embodiment, such content includes typed text plus margin notes, perhaps scribbled by a prior reader of the book. Thus what constitutes the original content 204 can vary from digitized document 102 to digitized document 102.

The original content 204 is typically automatically identified as a rectangular region surrounding text, photos, etc. in the digitized document page 202. Those skilled in the art, however, will recognize that the original content 204 could also be of a different shape, depending upon the original content 204 to be used for a later derivative work.

In one embodiment of the present invention, the original content 204 is identified using as much of the information that was originally captured in the digitized document page 202, while it is still available. Identifying the original content 204 before the digitized document page's 202 background color is removed and/or overall image is enhanced enables the content, in some cases, to be detected more effectively. This is in part because some automated methods for detecting the original content 204 often use background color information as well as other information otherwise lost due to image enhancement to distinguish content from the digitized document page 202.

Some embodiments of the present invention use an image enhancement module (not shown), which analyses the digitized document page 202 to compute an original background color of the digitized document page 202. Then, the image enhancement module uses this information to remove the original background color from the digitized document page 202.

A new content space identification module 108 calculates a blank space 304 (see FIG. 3) available in a new document page 302. The new document page 302 is herein defined as a derivative work (e.g. a finished document, target page, book, magazine, etc.) to be generated with the original content 204. While in a common embodiment, the new document page 302 area (e.g. size) will be the same or nearly the same as the digitized document page 202 area, in alternate embodiments, the new document page 302 area may be either larger or smaller than the digitized document page 202 area. The blank space 208 is herein defined as, equal to, the new document page 302 area, minus, the original content 204 area. The original content 204 area is an area taken by the original content 204 after any editing, scaling, resizing, reformatting, etc.

In the embodiment shown in FIGS. 2, 3, 4, and 5, the new document page 302 equals the digitized document page 202 area, and thus the blank space 304 equals the digitized document page 202 area minus the original content 204 area.

Next, the new content space identification module 108 defines a set of new edge margins 402 and a set of new inter-content margins 404 (see FIG. 4). These margins 402 and 404 may be of variable size depending upon a predetermined overall layout of the original content 204 on the new document page 302 (e.g. as the target output size of the new document page 302 changes, so may the width of the set of margins 402 and 404).

For example, if the new document page 302 target page size is a 6 inch by 9 inch format, the edge margins 402 for the top and bottom could be between 7/10 of an inch to ¾ of an inch. The edge margins 402 for the left and right side could be between ½ an inch to 6/10th of an inch.

In many embodiments of the present invention, the original content 204 will remain in the same place on the new document page 302 as the original content 204 occupied on the digitized document page 202. In other embodiments the predetermined overall layout may require that the original content 204 be moved to a different location on the new document page 302.

Typically, the set of edge margins 402 between the original content 204 and the edges of the new document page 302 will be the same as an original set of edge margins between the original content 204 and the edges of the digitized document page 202. However, the predetermined overall layout will likely specify a different set of inter-content margins 404 instantiated between the original content 204 and what will thereby by default be defined as a set of new content spaces 406. The set of new content spaces 406 (e.g. bounding boxes) are identified by the new content space identification module 108.

To further clarify, the set of new content spaces 406 (see FIG. 4) within the new document page 302 are herein defined as a set of areas remaining after the original content 204 area, the set of new edge margins 402 area, and the set of new inter-content margins 404 area have been subtracted from the new document page 302 area. While the set of new content spaces 406 shown in FIG. 4 are rectangular, in alternate embodiments, the set of flew content spaces 406 may be of any geometric shape.

The new content space identification module 108 preferably identifies most, if not all, of the new content spaces on new document pages 302 throughout a finished document 118. The new content space identification module 108 then characterizes each of the new content spaces 406 by a variety of attributes, including; a location in the digitized document 102; a location in the finished document 118; a location on the digitized document page 202; a location on a finished document page 504 (see FIG. 5); a total area of the new content space 406; a geometric shape of the new content space 406; and a fee to be charged for use of the new content space 406.

The new content space identification module 108 then stores a list of these new content spaces 406, and their attributes, for each of the digitized documents 102 in a new content space database 110.

Next, a new content addition module 112 searches a new content database 114 for new content 502 which is compatible with one or more of the new content spaces 406 (see FIG. 5). Compatibility is determined by comparing those attributes associated with the new content spaces 406 with attributes provided by a set of new content providers 116 and associated with the new content 502.

The new content 502 can be of any type, including those identified with respect to the original content 204. These types of new content 502 include: text, images, photos, media, videos, decorations, ornamentation, or any other type of content. In the present embodiment discussed, the new content 502 is a set of advertisements.

All of this new content 502 is stored in the new content database 114 by the new content providers 116. The new content 502 is typically dynamic and will vary over time, as the stock of new content 502 is continually augmented, culled, and modified in a variety of ways by the new content providers 116.

The new content providers 116 preferably have substantial, if not total, control over how the new content 502 is managed by the new content addition module 112. Clearly, by providing new content 502 or not, the new content providers 116 have a basic control over the new content 502; however, more frequently, the new content providers 116 will modify the attributes associated with the new content 502 in some way so as to continually ‘best position” the new content 502 in the finished document 118.

The attributes associated with the new content 502, includes: a payment to be made by the new content providers 116 for placement of the new content 502; a preferred set of locations for the new content 502 within the finished document 118; a preferred set of locations for the new content 502 within each of the finished document page 504; a minimum and/or maximum total area of the new content space 406 permissible for the new content 502; a scaling range of the new content 502 so that it can best fit in a new content space 406; a permissible and/or required set of geometric shapes for the new content 502; a date, time and/or duration over which the new content 502 item is to be displayed; and a derivative work in which the new content 502 will appear.

The new content addition module 112 preferably closely adheres to these specified attributes for the new content 502 when determining if any one item of new content 502 is compatible with any one or more of the new content spaces 406. Such adherence is strongly preferred since the new content providers 116 will in most, if not all, embodiments of the present invention be paying a fee for their new content 502 to be added to the finished document 118. This fee in turn supports businesses who facilitate the process of digitizing documents otherwise inaccessible paper documents.

The new content addition module 112 search, of the new content database 114 for new content 502 which is compatible with the new content spaces 406, can be conducted in a variety of ways. In other words, the new content addition module 112 can sort, group, and/or otherwise characterize both the new content spaces 406 in the new content space database 110, as well as the new content 502 in the new content database 114 in many different ways so as to best select new content 502 for each new content space 406. Such sorting, grouping, and characterizations, are preferably based on the respective attributes of the new content spaces 406 and the new content 502. For example, the new content spaces 406 could be sorted from largest to smallest, and the new content 502 could be sorted from a greatest to a least payment to be made by the new content providers 116.

Then, the new content addition module 112 formats and inserts the selected new content 502 (e.g. New Content—A, B, C, and D, see FIG. 5) from the new content database 114 into the new content spaces 406 to create the fished document pages 504 in the finished document 118.

The following are several examples of how new content 502 can be selected to fill a new content space 406. In these examples, the new content spaces 406 are in a book for printing on demand, the new content providers 116 are advertisers, and the new content 502 is a set of advertisements. However, in other embodiments of the present invention, the advertisers may limit instantiation of their advertisements to only certain derivative works (i.e. finished documents 118) each having their own unique set of attributes (i.e. “content placement rules”). These other derivative works include: web-pages, books, magazines, presentations, circulars, flyers, labels, and other types of finished documents 118.

To begin, the preferred set of locations for advertisements are typically toward either the front or at the very end of a book. Depending upon the advertisement, the preferred set of locations on each page of may be between two sets of paragraphs in the book, or to the right or left of a “thin” paragraph that does not span the full page width (e.g. FIG. 5c). However, in alternate examples, the advertisements could of course be placed on the top, bottom, or even in the margins of the book page.

The advertisers may specify a minimum acceptable total area so that the advertisements will be quite visible to a reader of the book. Other advertisers may set a minimum and maximum area limit, which may or may not be a function of the target size of the finished document 118. In some embodiments, the new content space identification module 108 may purposefully delete from consideration all new content spaces 406 which are smaller than an minimum limit (including those new document pages 302 that have no new content spaces 406) so as to avoid cluttering up the finished document 118.

In some embodiments, the advertisers may only permit the advertisements to be scaled (i.e. resized) larger, but only by a certain percentage so that the advertisements can best fit in certain new content spaces 406. Some specialty advertisers may prefer a triangular or star shape for their advertisement.

In many embodiments, the advertisers are likely to specify a range of date, times and durations for which their advertisements will be displayed. A set of the advertiser's ads may even be rotated over a predefined time period, such that the ads are cycled over time for greater variety. Such timing variability has particular applicability to when the derivative work fixed in a web page or cloud document, where as such variability may be less so for a printed on demand book.

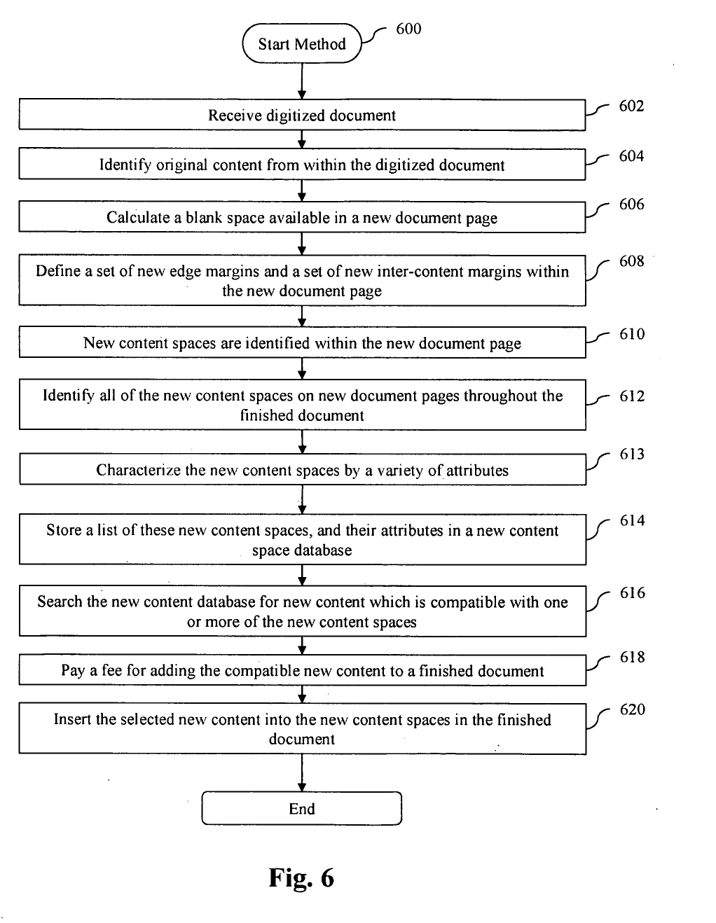

FIG. 6 is a flowchart of one embodiment of a method for adding content to a digitized document. Those skilled in the art will recognize that while one embodiment of the present invention's method is now discussed, the material in this specification can be combined in a variety of ways to yield other embodiments as well. The method steps now discussed are to be understood within a context provided by this and other portions of this detailed description.

The method 600 begins in step 602, by having the page detection module 104 receive the digitized document 102 from a source. In step 604, the original content identification module 106 identifies original content 204 from within the digitized document 102. Next in step 606, the new content space identification module 108 calculates a blank space 304 available in a new document page 302, wherein the blank space 208 is herein defined as, equal to, the new document page 302 area, minus, the original content 204 area.

In step 608, the new content space identification module 108 defines a set of new edge margins 402 and a set of new inter-content margins 404. Next in step 610, the set of new content spaces 406 am identified within the new document page 302 by the new content space identification module 108, wherein the set of new content spaces 406 within the new document page 302 are herein defined as a set of areas remaining after the original content 204 area, the set of new edge margins 402 area, and the set of new inter-content margins 404 area have been subtracted from the new document page 302 area.

In step 612, the new content space identification module 108 identifies most, if not all, of the new content spaces on new document pages 302 throughout the finished document 118. In step 613, the new content space identification module 108 then characterizes each of the new content spaces 406 by a variety of attributes

Next in step 614, the new content space identification module 108 then stores a list of these new content spaces 406, and their attributes, for each of the digitized documents 102 in a new content space database 110.

In step 616, the new content addition module 112 searches the new content database 114 for new content 502 which is compatible with one or more of the new content spaces 406. Next, in step 618, the new content providers 116 pay a fee for adding their compatible new content 502 to a finished document S118. In step 620, the new content addition module 112 inserts the selected new content 502 into the new content spaces 406 in the finished document 118.

A set of files refers to any collection of files, such as a directory of files. A “file” can refer to any data object (e.g., a document, a bitmap, an image, an audio clip, a video clip, software source code, software executable code, etc.). A “file” can also refer to a directory (a structure that contains other files).

Instructions of software described above are loaded for execution on a processor. The processor includes microprocessors, microcontrollers, processor modules or subsystems (including one or more microprocessors or microcontrollers), or other control or computing devices. A “processor” can refer to a single component or to plural components.

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations thereof. It is intended that the following claims cover such modifications and variations as fall within the true spirit and scope of the invention.

What is claimed is:

1. A method executed by a computer for adding content to a digitized document, comprising:
receiving the digitized document, formatted as an image file;
identifying a set of original content areas within the digitized document;
defining a set of new content space areas within a finished document as a set of areas remaining after the set of original content areas have been subtracted from a total area in the finished document; and
inserting a set of new content into the set of new content space areas.

2. The method of claim 1, wherein defining includes:
defining a new document page within the finished document; and
calculating a set of blank space areas available in the new document page by subtracting the original content areas placed on the new document page from a total area in the new document page.

3. The method of claim 2:
further comprising, defining a set of new edge margins and a set of new inter-content margins on the new document page;
wherein the margins are of variable size depending upon a predetermined overall layout of a subset of the original content on the new document page;
wherein defining includes, defining the set of new content spaces within the new document page as a set of areas remaining after the subset of original content areas, the set of new edge margins, and the set of new inter-content margins have been subtracted from the total new document page area.

4. The method of claim 1, further comprising:
deleting from the set of new content space areas all new content space areas which are smaller than a predefined minimum area.

5. The method of claim 1, wherein inserting includes:
identifying the new content space areas throughout the finished document;
characterizes the new content space areas by a variety of attributes;
storing a set of new content, along with an associated set of new content attributes, in a new content database;
searching the new content database for specific new content having at least one attribute that is compatible with at least one of the attributes of a specific new content space area; and
inserting the specific new content into the specific new content space area.

6. The method of claim 5, wherein the attributes associated with the new content space areas includes:
a location in the digitized document;
a location in the finished document;
a location on the digitized document page;
a location on a finished document page in the finished document;
a total area of the new content space;
a geometric shape of the new content space; and
a fee to be charged for use of the new content space.

7. The method of claim 5, wherein the attributes associated with the new content includes:
a payment to be made by a new content provider for placement of the new content;
a preferred set of locations for the new content within the finished document;
a preferred set of locations for the new content within a finished document page in the finished document;
a minimum total area of the new content space permissible for the new content;
a maximum total area of the new content space permissible for the new content;
a scaling range of the new content so that it can best fit in the new content space areas;
a set of geometric shapes for the new content;
a date on which the new content is to be displayed;
a time at which the new content is to be displayed;
a duration over which the new content is to be displayed; and
a derivative work in which the new content will appear.

8. The method of claim 5;
wherein the set of new content attributes are provided by a set of new content providers;
wherein the new content providers augment, cull, and modify the new content over time; and
wherein the new content providers augment, cull, and modify the set of new content attributes over time.

9. The method of claim 5,
wherein the set of new content attributes are provided by a set of new content providers; and
wherein the new content providers pay a fee for the new content to be added to the finished document.

10. The method of claim 5:
wherein the set of new content attributes are provided by a set of new content providers;
wherein the new content providers are advertisers; and
wherein the new content is a set of advertisements.

11. The method of claim 10:
wherein the set of advertisements are cycled through a same new content space in the finished document over a predefined time period.

12. The method of claim 5:
wherein the set of new content attributes are provided by a set of new content providers; and
further comprising, sorting both the new content spaces and the new content based on their respective attributes.

13. The method of claim 12, wherein sorting includes:
sorting the new content spaces by a largest to smallest size attribute; and
sorting the new content by a greatest to a least payment to be made by the new content providers.

14. The method of claim 1:
wherein the set of original content areas remains at a same location on a new document page in the finished document as the set of original content areas occupied on a digitized document page in the digitized document.

15. The method of claim 1:
wherein the digitized document is generated by imaging one of a group including: a book, a magazine, a photo, an image, a video, and media; and
wherein the original content includes one from a group including: text, an illustration, a picture, a photo, and a frame of video.

16. The method of claim 1:
wherein the set of new content includes one from a group including: advertisements, text, images, photos, media, videos, decorations, and ornamentation.

17. The method of claim 1:
wherein the finished document is one of a group including: a book for printing on demand; a web-page; a book; a magazine; a presentation; a circular; a flyer; and a label.

18. An article comprising at least one computer-readable storage medium containing instructions, that when executed cause a computer to add content to a digitized document, comprising;
receiving the digitized document, formatted as an image file;
identifying a set of original content areas within the digitized document;
defining a set of new content space areas within a finished document as a set of areas remaining after the set of original content areas have been subtracted from a total area in the finished document; and
inserting a set of new content into the set of new content space areas.

19. A system for adding content to a digitized document, comprising, a processor configured to operate a series of functional modules, including:
a page detection module for receiving the digitized document, formatted as an image file;
an original content identification module for identifying a set of original content areas within the digitized document;
a new content space identification module for defining a set of new content space areas within a finished document as a set of areas remaining after the set of original content areas have been subtracted from a total area in the finished document; and
a new content addition module for inserting a set of new content into the set of new content space areas.

20. The system of claim 1, further comprising:
new content providers for performing one from a group including augmenting, culling, and modifying the new content over time.
